(19) United States
(12) Patent Application Publication
(10) Pub. No.: US 2010/0147836 A1
(43) Pub. Date: Jun. 17, 2010

(54) ABRASION RESISTANT LOAD BIN

(76) Inventor: George Fechter Hoffmann, Johannesburg (ZA)

Correspondence Address: MERCHANT & GOULD PC, P.O. BOX 2903, MINNEAPOLIS, MN, 55402-0903, US

(21) Appl. No.: 12/527,947

(22) PCT Filed: Feb. 20, 2008
(86) PCT No.: PCT/ZA08/00014

§ 371 Date: Mar. 1, 2010

(30) Foreign Application Priority Data
Feb. 20, 2007 (ZA) 2007/01462

(51) Int. Cl. B65D 88/12; B65D 90/02; B65D 90/04; B29C 41/22

(52) U.S. Cl. 220/1.5; 220/626; 220/660; 156/243

(57) ABSTRACT

The invention relates to an abrasion resistant load bin for use to transport abrasive materials. The load bin includes a wear layer manufactured from polymeric material, which provide a wear surface, in use; and a second, backing layer manufactured from a non-deformable fibre reinforced polymeric material. The invention also describes methods to manufacture the load bin.

### TECHNICAL FIELD OF THE INVENTION

This invention relates to an abrasion resistant load bin for use in the transport of abrasive materials such as ore. The invention further relates to a method of manufacturing of an abrasion resistant load bin.

### BACKGROUND TO THE INVENTION

The inventor is aware that load bins for the transport of abrasive materials are made of steel and despite a relatively good wear resistance, such bins need regular replacement or repairs. Steel load bins also add substantial weight, which lower the load weight carrying capacity. The inventor found that a sprayed on layer of polyurethane greatly increased the abrasion wear resistance of steel load bins however, this added additional weight to the load bin. The inventor also invented, as described in South African Patent Application 2007/01462, abrasion resistant liners or panels for use in the transport of abrasive materials, which panels include a wear layer manufactured from polymeric material, which provides a wear surface, in use; and a second, backing layer manufactured from a non-deformable fibre reinforced polymeric material.

It is an object of this invention to provide a load bin that is more wear resistant to abrasive material than steel and which weigh less than steel load bins.

### GENERAL DESCRIPTION OF THE INVENTION

According to a first aspect of the invention there is provided an abrasion resistant load bin, which includes:
a wear layer manufactured from polymeric material, which provide a wear surface, in use; and
a second, backing layer manufactured from a non-deformable fibre reinforced polymeric material.

The thickness of the wear layer may vary between 4 and 8 mm depending on the type of ore to be carried and the expected wear patterns of the wear layer of the bin during use.

The load bin may include reinforcing ribs also made from a non-deformable fibre reinforced polymeric material, which ribs provide the strength to the bin. The ribs may define a cage. It will be appreciated that normal steel reinforcing ribs or cage can be used or purpose made ribs or cage from fibre reinforced polymeric material, or the fibre reinforced polymeric material reinforcing ribs or cage may be integrally formed with the backing layer manufactured from a non-deformable fibre reinforced polymeric material.

It will be appreciated that the phrase “non deformable” is used in the relative sense and does not mean absolute non deformability.

The polymeric material of the wear layer may be resiliently deformable material selected from synthetic polymers such as poly urethane modified with ester or ether groups. The selection of, or ratio of, ester and/or ether groups is selected to provide the required tribology characteristics of a panel for a specific application.

The non-deformable backing material may include glass fibre or carbon fibre reinforced resins such as epoxy resins or polyester resins.

According to a second aspect of the invention, there is provided a method of manufacturing an abrasion resistant load bin, which method includes the steps of:
applying a polymeric material to a required thickness onto a mould and allowing it to harden to form a wear layer; and
attaching a fibre reinforced backing layer to the wear layer.

The required thickness of the wear layer may vary between 4 and 8 mm depending on the type of ore to be carried and the expected wear patterns of the wear layer of the bin during use.

The wear layer may be applied by spraying.

The fibre reinforced backing layer may be applied in layers. A layer of strength adding reinforcing mat may be used between or in layers to add strength to the bin.

The method may include the step of covering the mould with a release agent.

The method may include the step of shaping a mould according to the required inside of the bin.

The fibre reinforced backing layer may be of a resin reinforced by fibre which may be attached to the wear layer by applying a layer of the resin to one side of the wear layer followed by applying a layer of the fibre in the form of a mat. Several layers, as dictated by the required stiffness of the backing layer, may be applied in this way and allowed to harden. It will be appreciated that the fibre mats differ from the strength adding mats, which are of a resin absorbing material between 2 and 4 mm thick instead of fibres and may have a honeycomb structure.

The bin may be lowered into a steel cage or steel reinforcing ribs and adhered to the steel by means of an adhesive, preferably a single component polyurethane based adhesive such as the adhesive marketed by Sika®, called: Sikaflex®-221.

It will be appreciated that an adhesive bond is advantageous over other attachment methods:
1. It is a continuous bond without localised stress points as formed by rivets or bolts.
2. It will absorb some of the stresses between the bins and steel ribs or cage, caused by vibration.
3. It won't wear out as the holes for rivets or bolts would over a period of time.
4. Work hardening won't take place as in the case with metal fatigue.

According to a third aspect of the invention, there is provided an alternative method of manufacturing an abrasion resistant load bin, which method includes the steps of:
applying a fibre reinforced backing layer into a mould; and
applying a polymeric material onto the backing layer and allowing it to harden to form a wear layer.

The wear layer may be applied by spraying. The wear layer may be applied after the backing layer has been attached to a cage or reinforcing ribs.

The bin may be lowered into a steel cage or steel reinforcing ribs and adhered to the steel by means of an adhesive, preferably a single component polyurethane based adhesive such as the adhesive marketed by Sika®, called: Sikaflex®-221.

The method may include the step of shaping a mould according to the required outside dimensions of the bin. The mould may be shaped to include negative formations for reinforcing ribs, which may define a cage so the ribs or cage is integrally formed with the backing layer of the bin.

Harden will be understood to include solidifying, curing, setting, cross-polymerising and the like ways in which polymers change from a liquid to a solid state.

The polymeric material may be poly urethane and its components may be sprayed with a Polyurethane spray machine at room temperature.

It will be appreciated that using a non steel backing layer and, alternatively fibre reinforced reinforcing ribs or a cage reduces weight and cost.

The hardness of the polymeric material may be selected to be between 50 A-Shore and 100 A-Shore scale as measured by an appropriate durometer and the thickness may vary between 4 and 15 mm.

### DETAILED DESCRIPTION OF THE INVENTION

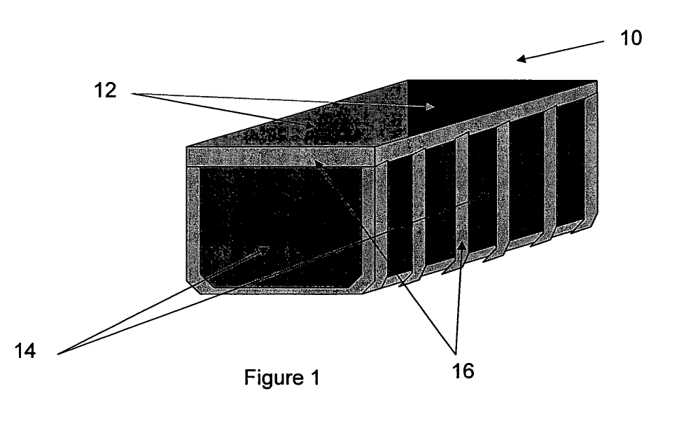

The invention is now described by way of example with reference to the following drawing wherein FIG. 1 shows diagrammatically a perspective view of an abrasion resistant load bin, in accordance with the invention.

In one example, an abrasion resistant load bin generally indicated by reference numeral 10 includes a wear layer 12 manufactured from polymeric material, which provide a wear surface, in use, and a second, backing layer 14 manufactured from a non-deformable fibre reinforced polymeric material.

The wear layer 12 is manufactured from poly urethane with a hardness of 90 A-Shore, and varies in thickness from 8 mm on the load carrying surface to 4 mm at the top edge of the sidewalls of the bin 10. The composition of the wear layer 2 comprises Polyester polyol and iso-cyanide, which is mixed while being sprayed and allowed to set. The backing layer 14 is manufactured from a non-deformable four layer glass fibre reinforced epoxy which sandwiches cormat strength adding mats.

The above described abrasion resistant load bin 10 is manufactured by spraying heated, 55° C., mixed poly urethane components material onto a pre-shaped mould and allowing it to cool and harden to form the wear layer. A glass fibre reinforced epoxy backing layer is applied to the outside of wear layer. A layer of epoxy is painted onto the side of the wear panel and a layer of glass fibre adhered thereto. This procedure is repeated until four layers are applied. In between layers, cormat strength adding mats are sandwiched.

The bin 10 is then removed and lowered into a steel rib structure, which defines a cage 16, with the contact areas of the cage and the bin being covered with an adhesive marketed by Sika®, called: Sikaflex®-221.

It shall be understood that the examples are provided for illustrating the invention further and to assist a person skilled in the art with understanding the invention and are not meant to be construed as unduly limiting the reasonable scope of the invention.

1. An abrasion resistant load bin, which comprises: a wear layer manufactured from polymeric material, which provide a wear surface, in use; and
a second, backing layer manufactured from a non-deformable fibre reinforced polymeric material.

2. A load bin as claimed in claim 1, wherein the thickness of the wear layer is selected to be between 4 and 8 mm.

3. A load bin as claimed in claim 1, wherein the thickness of the wear layer varies.

4. A load bin as claimed in claim 1, which includes reinforcing ribs.

5. A load bin as claimed in claim 4, wherein the reinforcing ribs are also made from a non-deformable fibre reinforced polymeric material.

6. A load bin as claimed in claim 5, wherein the ribs are integrally formed with the backing layer.

7. A load bin as claimed in claim 1, wherein the polymeric material of the wear layer is resiliently deformable material selected from synthetic polymers such as poly urethane modified with ester or ether groups.

8. A load bin as claimed in claim 7, wherein the selection of, or ratio of, ester and/or ether groups is selected to provide the required tribology characteristics of the wear surface of wear layer of the bin for a specific application.

9. A load bin as claimed in claim 1, wherein the non-deformable backing material is selected from glass fibre or carbon fibre reinforced resins such as epoxy resins or polyester resins.

10. A method of manufacturing an abrasion resistant load bin as claimed in claim 1, which method comprises the steps of:
applying a polymeric material to a required thickness onto a mould and allowing it to harden to form a wear layer; and
attaching a fibre reinforced backing layer to the wear layer.

11. A method as claimed in claim 10, wherein the wear layer is applied by spraying.

12. A method as claimed in claim 10, wherein the fibre reinforced backing layer is applied in layers.

13. A method as claimed in claim 12, wherein a layer of strength adding reinforcing mat is placed between layers.

14. A method as claimed in claim 10, which includes the step of lowering the formed bin into a steel cage or steel reinforcing ribs and adhering it to the steel by means of an adhesive.

15. A method of manufacturing an abrasion resistant load bin as claimed in claim 1, which method comprises the steps of:
applying a fibre reinforced backing layer into a mould; and
applying a polymeric material onto the backing layer and allowing it to harden to form a wear layer.

16. A method as claimed in claim 15, wherein the wear layer is applied after the backing layer has been attached to a cage or reinforcing ribs.

17. A method as claimed in claim 15, which method comprises the step of shaping a mould according to the required outside dimensions of the bin and to include negative formations for reinforcing ribs.

18. (canceled)

19. (canceled)
